(19) United States
(12) Patent Application Publication
(10) Pub. No.: US 2008/0282878 A1
(43) Pub. Date: Nov. 20, 2008

(54) Pneumatic rotary actuator

(76) Inventor: Cheng-Chung Chai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,651

(22) Filed: May 16, 2007

(51) Int. Cl. B23B 3/00

(52) U.S. Cl. 92/2

(57) ABSTRACT

A pneumatic rotary actuator includes a housing formed of a front shell and a rear shell, a shaft tube inserted through the housing, a piston fixedly mounted on the shaft tube and dividing the inside space of the housing into a front air chamber and a rear air chamber, a rotary member provided around the shaft tube and defining an air gap around the shaft tube in communication with the rear air chamber, an inner race mounted around the rotary member, a locknut fastened to the rotary member to lock the inner race to the rotary member, and a locating frame supported on a bearing around the inner race and having a first air inlet for guiding compressed air to the front air chamber through a first air passageway to move the piston and the shaft tube backwards and to further force a chucking head to grip the workpiece and a second air inlet for guiding compressed air into the rear air chamber to move the piston and the shaft tube forwards and to further release the chucking head from the workpiece.

### BACKGROUND OF THE INVENTION

1. Field of the Invention

The present invention relates to a rotary actuator and more particularly, to a pneumatic rotary actuator.

2. Description of the Related Art

A conventional rotary actuator for driving a chucking head to grip a workpiece uses hydraulic pressure to move the parts, i.e., hydraulic oil is controlled to move the parts, causing the chucking head to grip or release the workpiece. The use of hydraulic oil cannot completely eliminate oil contamination. Further, it requires much space for the installation of the hydraulic system. The installation cost of the oil pump is high.

### SUMMARY OF THE INVENTION

The present invention has been accomplished under the circumstances in view. It is the main object of the present invention to provide a rotary actuator, which uses pneumatic force to move parts, eliminating environmental contamination. According to one aspect of the present invention, the pneumatic rotary actuator comprises a housing formed of a front shell and a rear shell, a shaft tube inserted through the housing, a piston fixedly mounted on the shaft tube and dividing the inside space of the housing into a front air chamber and a rear air chamber, a rotary member provided around the shaft tube and defining an air gap around the shaft tube in communication with the rear air chamber, an inner race mounted around the rotary member, a locknut fastened to the rotary member to lock the inner race to the rotary member, and a locating frame supported on a bearing around the inner race and having a first air inlet for guiding compressed air to the front air chamber through a first air passageway to move the piston and the shaft tube backwards and to further force a chucking head to grip the workpiece and a second air inlet for guiding compressed air into the rear air chamber to move the piston and the shaft tube forwards and to further release the chucking head from the workpiece. According to another aspect of the present invention, the inner race has a plurality of air holes equiangularly spaced around the periphery, and only one air hole is in action to guide compressed air from the first air inlet to the front air chamber or from the second air inlet to the rear air chamber, lowering the risk or air leakage.

### BRIEF DESCRIPTION OF THE DRAWINGS

FIG. 1 is a sectional view of a pneumatic rotary actuator according to the present invention.

FIG. 1A is a sectional view taken along line A-A of FIG. 1.

FIG. 2 is an applied view in section of the pneumatic rotary actuator according to the present invention, showing the pull shaft and the shaft tube moved backwards and the chucking head gripped the workpiece.

FIG. 3 is similar to FIG. 2 but showing the pull shaft and the shaft tube moved forwards and the chucking head released from the workpiece.

FIG. 4 is an applied view in section of an alternate form of the pneumatic rotary actuator according to the present invention, showing the pull shaft and the shaft tube moved backwards and the chucking head gripped the workpiece.

FIG. 5 is similar to FIG. 4 but showing the pull shaft and the shaft tube moved forwards and the chucking head released from the workpiece.

### DETAILED DESCRIPTION OF THE PREFERRED EMBODIMENT

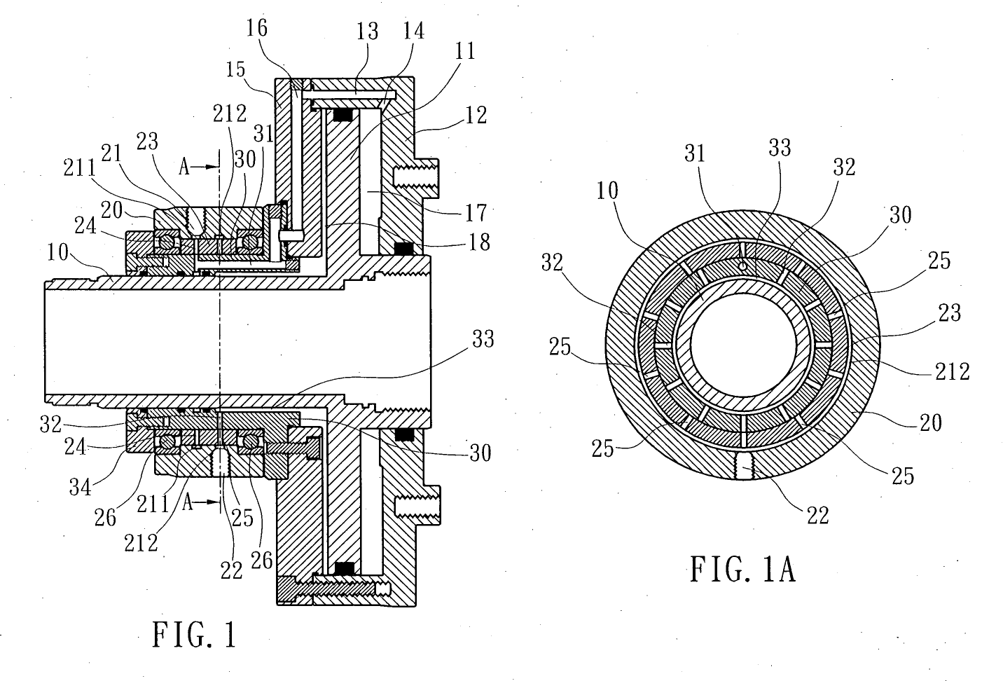

Referring to FIGS. 1, 1A, 2 and 3, a pneumatic rotary actuator in accordance with the present invention is shown comprising a shaft tube 10, a piston 11, a front shell 12, a rear shell 15, a locating frame 20, an inner race 23, a rotary member 30, and a locknut 34.

The front shell 12 and the rear shell 15 are fixedly fastened together to support the shaft tube 10. The piston 11 is fixedly mounted around the shaft tube 10 and suspending in between the front shell 12 and the rear shell 15, dividing the inside space within the front shell 12 and the rear shell 15 into a front air chamber 17 and a rear air chamber 18. The front shell 12 has a connection hole 13 and an air hole 14 disposed in communication with the front air chamber 17. The rear shell 15 has an air passage 16 in communication with the connection hole 13 of the front shell 12.

The rotary member 30 is a provided around the shaft tube 10, defining an air gap 33 around the shaft tube 10 in communication with the rear air chamber 18 and having an air passage 31 in communication with the air passage 16 of the rear shell 15 and a plurality of air holes 32 equiangularly spaced around the periphery in communication between the air gap 33 and the outside space.

The inner race 23 is mounted around the periphery of the rotary member 30, having a plurality of first air holes 24 equiangularly spaced around the periphery in communication between the air passage 31 and the outside space and a plurality of second air holes 25 equiangularly spaced around the periphery in communication between the air holes 32 and the outside space.

The locating frame 20 is supported on a bearing 26 around the inner race 23, having a first air inlet 21, a second air inlet 22, a first inside air groove 211 in communication between the first air inlet 21 and the first air holes 24 of the inner race 23, and a second inside air groove 212 in communication between the second air inlet 22 and the second air holes 25 of the inner race 23.

The locknut 34 is mounted around the shaft tube 20 and fastened to the rotary member 30 to lock the bearing 26 and the inner race 23 to the rotary member 20.

The shaft tube 10 is installed in a machine base to support a main shaft 40 and adapted to move a pull tube 41 and a chucking head 42 in the main shaft 40.

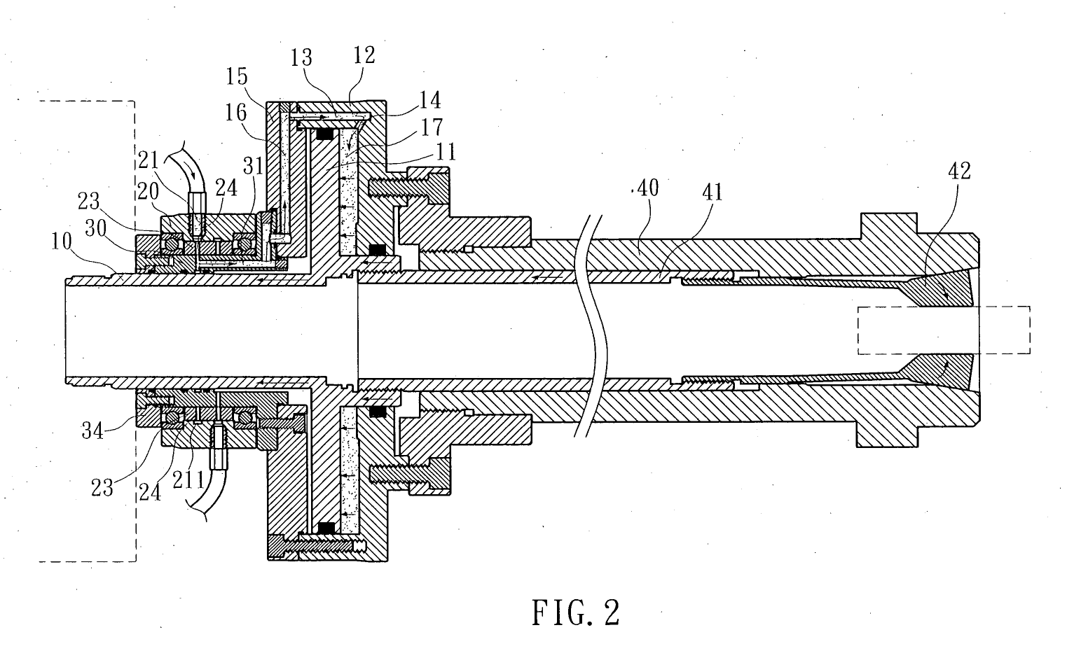

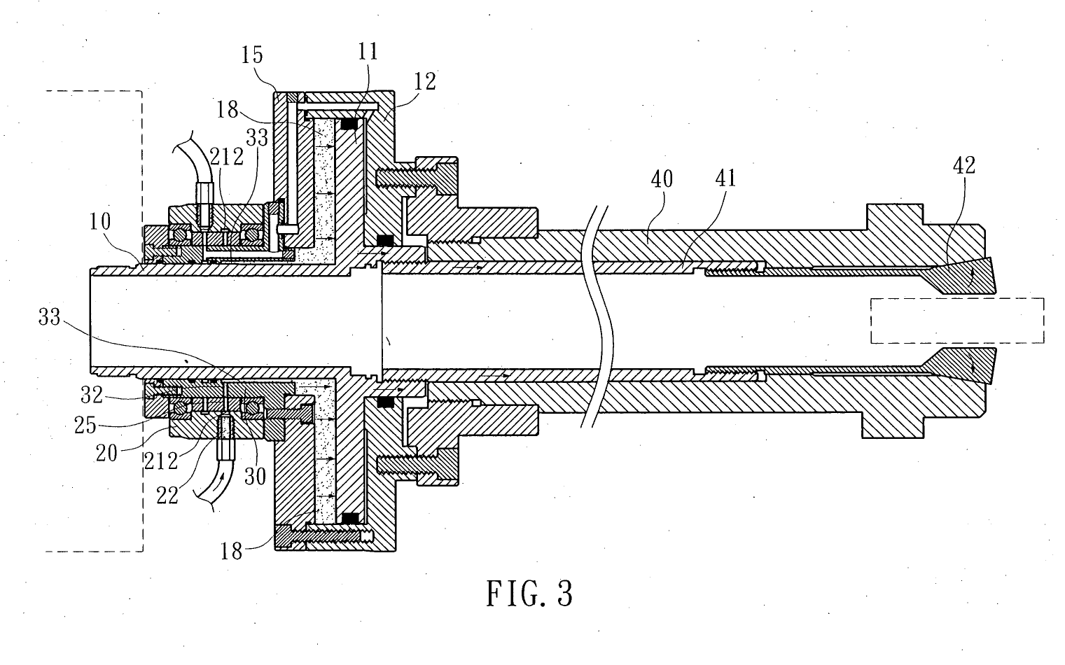

Referring to FIGS. 2 and 3, the main shaft 40 is fastened to the front shell 12 to hold the pull tube 41 on the inside, and the chucking head 42 is connected to the pull tube 41. The chucking head 42 is forced to grip the workpiece when moved backwards with the push tube 41 (see FIG. 2). On the contrary, the chucking head 42 releases the workpiece when moved forwards with the push tube 41 (see FIG. 3). When compressed air is guided into the first air inlet 21, compressed air goes through the first inside air groove 211 of the locating frame 20 into the first air holes 24 of the inner race 23 and then into the air passage 16 of the rear shell 15 through the air passage 31 of the rotary member 30 and then through the connection hole 13 and air hole 14 of the front shell 12 into the front air chamber 17 to move the piston 11 and the shaft tube 10 backwards, and therefore the pull tube 41 is driven by the shaft tube 10 to move the chucking head 42 backwards and to further grip the workpiece (see FIG. 2). On the contrary, when compressed air is guided into the second air inlet 22, compressed air goes through the second inside air groove 212 of the locating frame 20 into the second air holes 25 of the inner race 23 and then through the air gap 33 into the rear air chamber 18 to move the piston 11 and the shaft tube 10 forwards, and therefore the pull tube 41 is driven by the shaft tube 10 to move the chucking head 42 forwards and to further release the workpiece (see FIG. 3).

Further, as shown in FIG. 1A, the inner race 23 has multiple first air holes 24 in communication with the first inside air groove 211 and multiple second air holes 25 in communication with the second inside air groove 212, and the multiple second air holes 25 of the inner race 23 are disposed in communication with the air holes 32 of the rotary member 30, compressed air is positively supplied to the front air chamber 17 or rear air chamber 18 during rotation of the shaft tube 10. Further, because the invention allows ventilation through “hole” but not full circular ventilation, air leakage is minimized, and a small air pump can be used to provide sufficient air pressure to move the piston 11 and the shaft tube 10. Further, because the invention uses compressed air to move the piston 11 and the shaft tube 10 instead of hydraulic oil, the invention eliminates oil contamination.

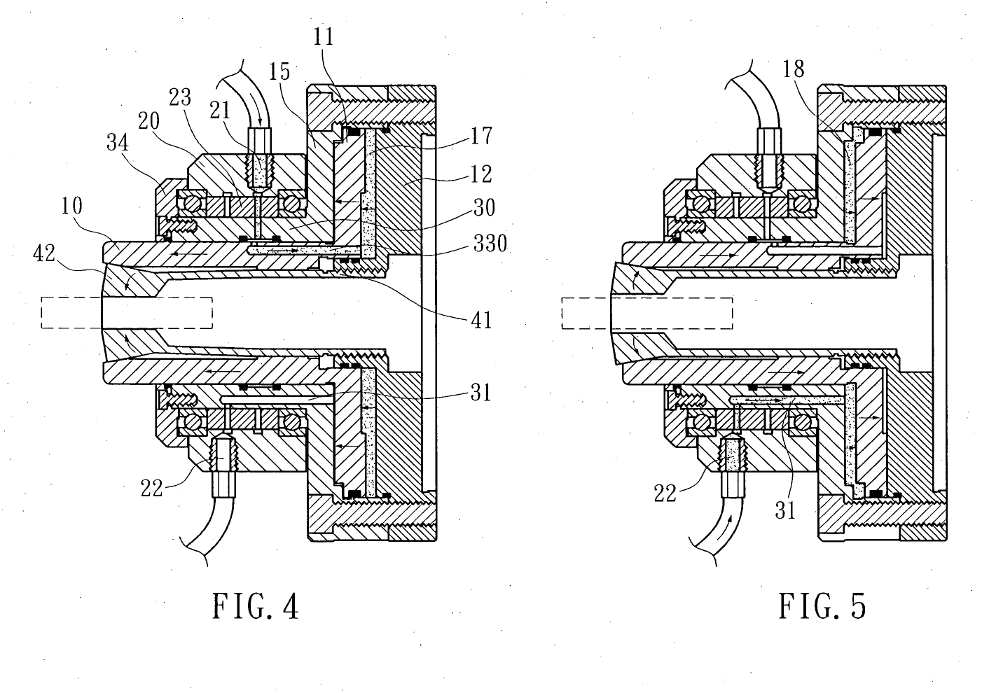

FIGS. 4 and 5 show an alternate form of the present invention. According to this embodiment, the air passage 16 of the rear shell 15 and the connection hole 13 and air hole 14 of the front shell 12 are eliminated; the shaft tube 10 has a relatively greater wall thickness and an air passage 330 in communication with the front air chamber 17. This embodiment achieves the same effects.

A prototype of pneumatic rotary actuator has been constructed with the features of FIGS. 1˜5. The pneumatic rotary actuator functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A pneumatic rotary actuator comprising:
a front shell and the rear shell fixedly fastened together, said front shell having a connection hole and an air hole, said rear shell having an air passage in communication with the connection hole of said front shell;
a shaft tube inserted through said front shell and said rear shell and adapted to move a pull tube and a chucking head forwards/backwards relative to a hollow main shaft around said pull tube;
a piston fixedly mounted around said shaft tube and suspending in between said front shell and said rear shell and dividing the inside space within said front shell and said rear shell into a front air chamber in communication with the connection hole and air hole of said front shell and a rear air chamber;
a rotary member provided around said shaft tube, said rotary member defining an air gap around said shaft tube in communication with said rear air chamber, said rotary member having an air passage in communication with the air passage of said rear shell and a plurality of air holes equiangularly spaced around the periphery thereof in communication between said air gap;
an inner race mounted around the periphery of said rotary member, said inner race having a plurality of first air holes equiangularly spaced around the periphery thereof in communication between the air passage of said rotary member and a plurality of second air holes in communication with the air holes of said rotary member;
a locating frame supported on a bearing around said inner race, said locating frame having a first air inlet, a second air inlet, a first inside air groove in communication between said first air inlet and the first air holes of said inner race, and a second inside air groove in communication between said second air inlet and the second air holes of said inner race; and.
a locknut mounted around said shaft tube and fastened to said rotary member to lock said bearing and said inner race to said rotary member;
wherein:
when compressed air is guided into said first air inlet, compressed air goes through the first inside air groove of said locating frame into the first air holes of said inner race and then into the air passage of said rear shell through the air passage of said rotary member and then through the connection hole and air hole of said front shell into said front air chamber to move said piston and said shaft tube backwards;
when compressed air is guided into said second air inlet, compressed air goes through the second inside air groove of said locating frame into the second air holes of said inner race and then through said air gap into said rear air chamber to move said piston and said shaft tube forwards.

2. The pneumatic rotary actuator as claimed in claim 1, wherein said shaft tube has an air passage in communication with said front air chamber, said first air inlet, the air holes of said rotary member and the air holes of said inner race.
